(19) United States
(12) Patent Application Publication
(10) Pub. No.: US 2025/0005497 A1
(43) Pub. Date: Jan. 2, 2025

(54) SIMULATION SYSTEM AND COMPUTER-READABLE MEDIUM

(71) Applicant: TOYOTA JIDOSHA KABUSHIKI KAISHA, Aichi-ken (JP)

(72) Inventors: Takahiro SAKURAI, Nagoya-shi (JP); Shigefumi TOKUDA, Susono-shi (JP); Kensuke MATSUMOTO, Nagoya-shi (JP); Masafumi KADOI, Chita-shi (JP); Yoshio TAKIZAWA, Katsushika-ku (JP); Takumi BAN, Setagaya-ku (JP); Ambi SHO, Nisshin-shi (JP); Tomoyuki KAGA, Mishima-shi (JP); Hideo HASEGAWA, Nagoya-shi (JP); Kenta MIYAHARA, Edogawa-ku (JP); Shinsuke YAMAUCHI, Toyota-shi (JP)

(21) Appl. No.: 18/752,792

(22) Filed: Jun. 25, 2024

(30) Foreign Application Priority Data
Jun. 29, 2023 (JP) 2023-107400

(51) Int. Cl. G06Q 10/067; G06Q 10/0631

(52) U.S. Cl. CPC G06Q 10/067; G06Q 10/063116

(57) ABSTRACT

A digital twin simulation is performed. In this simulation, combinations of workers and mounting fixtures worn by the workers are assigned to each of multiple works to be performed in a work line of a digital space based on data related to work contents of the multiple works to be performed in the work line of a real space, and data related to multiple workers arranged in the work line and data related to mounting fixtures worn by the multiple workers. Then, based on the assigned combinations, a group of combinations of the multiple workers and the mounting fixtures worn by the respective multiple workers in a case where a reference condition is satisfied are searched.

### CROSS-REFERENCE TO RELATED APPLICATION

The present application claims priority under 35 U.S.C. § 119 to Japanese Patent Application No. 2013-107400, filed on Jun. 29, 2023, the contents of which application are incorporated herein by reference in their entirety.

### TECHNICAL FIELD

The present disclosure relates to a system and a computer-readable medium for performing simulation related to a work line.

### BACKGROUND

JP2021-089598A disclose an apparatus for managing a workload of a worker wearing a device for assisting work by the worker. This apparatus of the related art acquires behavior information on the worker wearing the assistance device. The apparatus also calculates an assessment value related to a fatigue level of the worker wearing the assistance apparatus based on the behavior information. The assessment value related to the fatigue level is calculated for each worker wearing the same assistance apparatus. The apparatus further distributes the work of the worker having a high fatigue level to the worker having a low fatigue level.

Examples of references showing the technical level of the technical field relating to the present disclosure include JP2022-069956A and JP2017-177412A, in addition to JP2021-089598A.

The assistance device is classified as a mounting fixture worn by the worker. Such mounting fixtures include not only an auxiliary tool for assisting work but also a protector for protecting the worker from a work environment.

It is expected that a work efficiency of the worker increases or decreases depending on whether the worker wears the mounting fixture and a wearing time (using time) of the mounting fixture. If such a change can be predicted in advance, it is possible to take necessary measures. Examples of the necessary measure include to assign the worker to the work requiring wearing of the mounting fixture that increases the work efficiency of the worker. Examples of the necessary measure also include to remove the worker from the work requiring wearing of the mounting fixture before the wearing time of the mounting fixture becomes long and the work efficiency of the worker is lowered.

In particular, in a work line in which multiple works are cooperatively performed by multiple workers, the increase or decrease in the work efficiency of the worker due to the mounting fixture affects the work efficiency in a whole work line. Therefore, there is room for development from this aspect.

An object of the present disclosure is to provide a technique capable of increasing a work efficiency in a whole work line in which multiple works are cooperatively performed by multiple workers, in consideration of changes in the work efficiency of the multiple workers due to mounting fixtures worn by the multiple workers.

### SUMMARY

A first aspect of the present disclosure is a simulation system and has the following features.

The simulation system includes a database and a processor. The database stores data related to multiple workers arranged in a work line of a real space, data related to mounting fixtures worn by the respective multiple workers, and data related to indexes on work efficiency of the multiple workers, in association with work contents of multiple works performed in the work line of the real space. The processor is configured to perform a simulation on a work line in a digital space corresponding to the work line in the real space based on data related to a work plan in the work line in the real space and data stored in the database.

The data of the work plan in the work line of the real space includes data of work contents of the multiple works to be performed in the work line of the real space.

In the simulation, the processor is configured to:
assign combinations of workers and mounting fixtures worn by the workers to each of the work contents of the multiple works performed in the work line of the digital space based on the data related to the work contents of the multiple works to be performed, and the data related to the multiple workers and the data related to the mounting fixture stored in the database; and
based on the assigned combinations and the data related to the indexes stored in the database, which are data of indexes related to work efficiencies of the worker constituting the assigned combinations, search for a group of combinations of the multiple workers and the mounting fixtures worn by the respective multiple workers, in a case where a reference condition in which work efficiency in a whole work line of the digital space is equal to or greater than a target value is satisfied.

A second aspect of the present disclosure is a non-transitory computer-readable medium storing a simulation program and has the following features.

The simulation program causes a computer to perform a simulation in a work line of a digital space corresponding to a work line of a real space.

In the simulation, the simulation program causes the computer to perform:
assign combinations of workers and mounting fixtures worn by the workers to each of multiple works performed in the work line of the digital space, based on data of work contents of the multiple works to be performed in the work line of the real space, data related to multiple workers arranged in the work line of the real space, and data related to mounting fixtures worn by the multiple workers; and
based on the assigned combinations and data of indexes related to work efficiencies of the workers constituting the assigned combinations, search for a group of combinations of the multiple workers and the mounting fixtures worn by the respective multiple workers in a case where a reference condition in which work efficiency in a whole work line of the digital space is equal to or greater than a target value is satisfied.

According to the present disclosure, the simulation is performed for the work line in the digital space corresponding to the work line in the real space. In this simulation, the group of the combinations of the multiple workers and the mounting fixtures worn by the respective multiple workers are searched for in a case where the reference condition in which a work efficiency in a whole work line of the digital space is equal to or greater than the target value is satisfied. According to the group of the combinations in the case where the reference condition is satisfied, when the work line of the real space is operated with reference to this group, it is expected that the work efficiency in the whole work line is increased. Therefore, according to the present disclosure, in the work line in which the multiple works are cooperatively performed, it is possible to increase the work efficiency in the whole work line in consideration of changes in the work efficiencies of the multiple workers due to the mounting fixtures worn by the respective multiple workers.

### BRIEF DESCRIPTION OF DRAWINGS

FIG. 1 is a diagram for illustrating an example of a work line to which an embodiment is applied;

FIG. 2 is a diagram for illustrating an example of setting an index related to a work efficiency of a worker;

FIG. 3 is a diagram for illustrating an outline of a simulation according to the embodiment;

FIG. 4 is a diagram for illustrating a configuration example of a simulation system according to the embodiment;

FIG. 5 is a diagram for illustrating a configuration example of worker data; and

FIG. 6 is a diagram for illustrating a configuration example of worker data for simulation.

### DESCRIPTION OF EMBODIMENT

Hereinafter, embodiments of the present disclosure will be described with reference to the drawings. In the drawings, the same or corresponding parts are denoted by the same reference numerals, and the description thereof will be simplified or omitted.

### 1. Work line

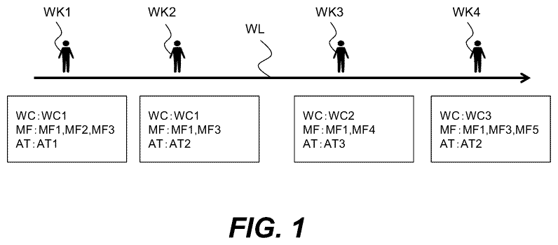

FIG. 1 is a diagram for illustrating an example of a work line to which an embodiment of the present disclosure is applied. A work line WL depicted in FIG. 1 is a line for cooperatively performing various operations such as production, storage, and packaging of products. The work line WL is provided in a site of a factory that mass-produces products, in a site of a distribution warehouse that stores products and raw materials thereof or packs and ships products, and in a site of a distribution center that receives, inspects, stores, picks, packs, and ships products.

Multiple workers are arranged in the work line WL. These workers are engaged in various kinds of work performed in cooperation with each other in the work line WL. Workers WK1, WK2, WK3, and WK4 shown in FIG. 1 are examples of multiple workers arranged in the work line WL. The workers WK1 and WK2 are engaged in the work of the work contents WC1. The worker WK3 is engaged in the work of the work contents WC2, and the worker WK4 is engaged in the work of the work contents WC3. Hereinafter, for convenience of description, when any one of the multiple workers is referred to, the worker is also referred to as a “worker WKx”.

When performing various works, the worker WKx wears various mounting fixtures MF. As the mounting fixture MF, a protector for protecting the worker WKx from the working environment is exemplified. The mounting fixture MF includes an auxiliary tool for assisting the work performed by the worker WKx and a measurement tool for measuring the physical condition of the worker WKx. The mounting fixture MF includes a mounting fixture MF that is required to be worn by the worker WKx by laws, regulations, or the like and a mounting fixture MF that is not required to be worn by the worker WKx (that is, a mounting fixture MF that is arbitrarily worn). Generally, most of the protective equipment is classified into the former. On the other hand, many of the auxiliary tools and the measuring tools are classified into the latter.

The mounting fixtures MF1, MF2, MF3, MF4, and MF5 shown in FIG. 1 are examples of the mounting fixture MF. The worker WK1 wears the mounting fixture MF1, MF2 and MF3. The worker WK2 wears the mounting fixture MF1 and the MF3. The worker WK3 wears the mounting fixture MF1 and the MF4. The worker WK4 wears the mounting fixture MF1, MF3 and MF5. The reason why the types of the mounting fixture MF are different between the worker WK1 and the worker WK3 and between the worker WK1 and the worker WK4 is that the work contents WC are different. The mounting fixture MF is different between the worker WC1 and the worker WK2 who are engaged in the work of the same work contents WC (that is, the work contents WK1), which means that wearing of the mounting fixture MF2 is at least optional.

In FIG. 1, the attribution AT of the worker MKx is also shown. The attribution AT is determined by using attributing elements such as basic attributes such as age and sex, physical attributes such as height and weight, and labor attributes such as the number of years of experience of work in the work line WL. In the example shown in FIG. 1, the attribution AT of the worker WK1 is attribution AT1, the attribution AT of the worker WK2 is attribution AT2, and the attribution AT of the worker WK3 is attribution AT3. The attribution AT of the worker WK4 is the same as that of the worker WK2.

### 2. Features of Embodiment

In the embodiment, simulation using digital space (hereinafter, also referred to as “digital twin simulation” or “DTS”) is performed. The digital space is reproduced based on the real space in which the work line WL described in FIG. 1 is provided. In the DTS, various kinds of work that are the same as the various kinds of work performed in the work line WL of the real space are performed in the digital space, and a future state in the work line WL is predicted. The future state includes the work efficiency WE_WWL of the entire work line WL.

As a factor that affects the work efficiency WE_WWL, the work efficiency WE_WKx of the worker WKx is assumed. Further, as factors that affect the work efficiency WE_WKx, work contents WC, a mounting fixture MF worn in the work contents WC, a wearing time of the mounting fixture MF, and the like are assumed. Therefore, in the embodiment, the index IN_WE_WKx related to the work efficiency WE_WKx is calculated by focusing on these factors that affect the work efficiency WE_WKx. Then, the work efficiency WE_WWL is calculated using the index IN_WE_WKx.

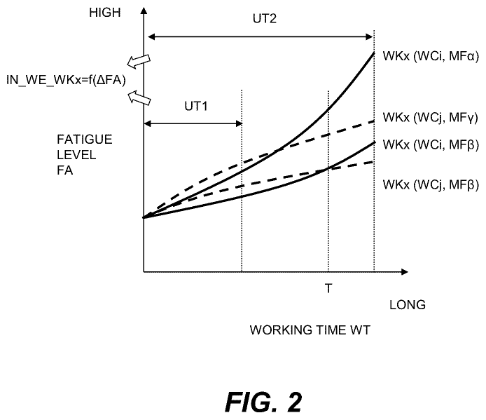

FIG. 2 is a diagram for illustrating an example of calculation of index IN_WE_WKx. The vertical axis of FIG. 2 shows the fatigue level FA of the worker WKx, and the horizontal axis of FIG. 2 shows the working time (elapsed time after the start of the work) WT. The fatigue level FA is a variable having a correlation with the work efficiency WE_WKx, and is suitable for setting the index IN_WE_WKx in that the degree of the correlation can be expressed by a numerical value. As the correlation, a relationship in which the work efficiency WE_WKx decreases as the fatigue level FA increases is exemplified. Note that any variable (for example, a degree of concentration or arousal level) that has a correlation with the work efficiency WE_WKx and can represent the degree of correlation by a numerical value can be used for setting the index IN_WE_WKx instead of the fatigue level FA or in combination with the fatigue level FA.

In FIG. 2, four combinations (WC, MF) of work contents WC and mounting fixture MF for worker WKx are drawn. The combinations (WC, MF)=(WCi, MFα) and (WC, MF)=(WCi, MFβ) drawn by solid lines have the work contents WC in common and differ in the mounting fixture MF. When the courses of the fatigue level FA of the two sets are compared, it is understood that the fatigue level FA in the case where the worker WKx wears the mounting fixture MFα has a higher rate of rise of the fatigue level FA than that in the case where the worker WKx wears the mounting fixture MFβ. That is, it is understood that when the worker WKx wears the mounting fixture MFα, the work efficiency WE_WKx is reduced as compared with the case where the worker WKx wears the mounting fixture MFβ.

The combinations (WC, MF)=(WCj, MFγ) and (WC, MF)=(WCj, MFβ) drawn by broken lines are common in the work contents WC and the work contents WCj, and are different in the mounting fixture MF. When the courses of the fatigue level FA of the two sets are compared, it is understood that the fatigue level FA in the case where the worker WKx wears the mounting fixture MFγ has a higher rate of rise of the fatigue level FA than that in the case where the worker WKx wears the mounting fixture MFβ. That is, it is understood that when the worker WKx wears the mounting fixture MFγ, the work efficiency WE_WKx is reduced as compared with the case where the worker WKx wears the mounting fixture MFβ.

Attention is paid to the combinations (WC, MF)=(WCi, MFβ) and (WC, MF)=(WCj, MFβ). The two combinations have the same mounting fixture MF and different work contents WC. When the changes in fatigue level FA are compared for these combinations, it is understood that the magnitude relationship between the fatigue level FA when the worker WKx has performed the work of the work contents WCi and the fatigue level FA when the worker WKx has performed the work of the work contents WCj is reversed at the time point T. That is, it is understood that when the worker WKx performs the work of the work contents WCi for a long time, the work efficiency WE_WKx decreases at the time point T.

Based on the relationship between the combination (WC, MF) and the transition of the fatigue level FA described above, the index IN_WE_WKx is calculated using the variation ΔFA of the fatigue level FA per unit time UT in the embodiment. The unit time UT is a time width such as 30 minutes, 1 hour, or 4 hours. Two or more kinds of unit time UT may be set. In this case, the unit time UT is exemplified by a first time UT1 and a second time UT2 (UT1<UT2). Any time can be set as the unit time UT. For example, the first time UT1 is assumed to be a short-term variation ΔFA, and the second time UT2 is assumed to be a long-term variation ΔFA.

When two or more kinds of unit time UT are set, a plurality of indexes IN_WE_WKx can be calculated for one kind of combination (WC, MF). In this case, for example, the index IN_WE_WKx can be calculated using the variation ΔFA corresponding to the work time of the work contents WC. This is expected to lead to improvement in the prediction accuracy of work efficiency WE_WWL performed by DTS.

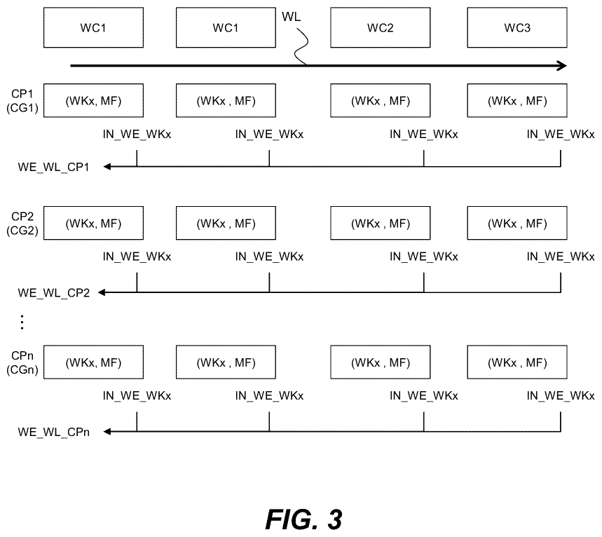

FIG. 3 is a diagram for illustrating an outline of the DTS according to the embodiment. As illustrated in FIG. 3, in the DTS according to the embodiment, a combination (WKx, MF) of one worker WKx and a mounting fixture MF worn by the worker WKx is assigned to each of work contents WC of multiple works performed in cooperation with a work line WL. When a combination (WKx, MF) to be distributed to a single work contents WC is specified, an index IN_WE_WKx when a worker WKx constituting the combination (WKx, MF) wears a mounting fixture MF constituting the combination (WKx, MF) is specified. Then, the work efficiency WE_WWL can be calculated based on the identified index IN_WE_WKx. The work efficiency WE_WWL is calculated using, for example, a calculation formula in which the specified index IN_WE_WKx is a variable.

In the DTS according to the embodiment, the assignment of the combination (WKx, MF) to the work contents WC of the multiple works is further performed on all the patterns CP of the combinations (WKx, MF) to which the assignment is possible (CP1 to CPn). Then, the work efficiency WE_WWL is calculated for each pattern CP of the combination (WKx, MF). When the work efficiency WE_WWL is calculated for each pattern CP of the combination (WKx, MF), the work efficiency WE_WWL is selected using the following reference condition.

Reference condition: work efficiency WE_WWL is equal to or greater than a target value TG

Thus, the pattern CP of the combination (WKx, MF) when the reference condition is satisfied is specified. Note that a value separately set based on the work planWP in the work line WL is applied to the target value T G.

The pattern CP of the combination (WKx, MF) when the reference condition is satisfied can be considered as a group of combinations (WK, MF) of multiple workers and mounting fixtures MF worn by the multiple workers. In the DTS according to the embodiment, a search for specifying the group CG of such a combination (WK, MF) is performed. As a result of the search, when the group CG of the combination (WK, MF) is specified, if the work line WL of the real space is operated with reference to the group CG, it is expected that the work efficiency WE_WWL of the entire work line WL is increased.

In order to operate the work line WL of the real space by referring to the group CG of the specified combination (WK, MF), it is necessary to perform the assignment of the worker WKx to the multiple works to be executed in the work line WL (the distribution of the combination (WKx, MF) to the work contents WC of the multiple works). Therefore, in the embodiment, “staff assignment processing” of arranging the worker WKx in the work line WL of the real space is performed using the result of the search by the DTS. Details of the staff assignment processing will be described later.

### 3. Configuration Example

### 3-1. System Configuration Example

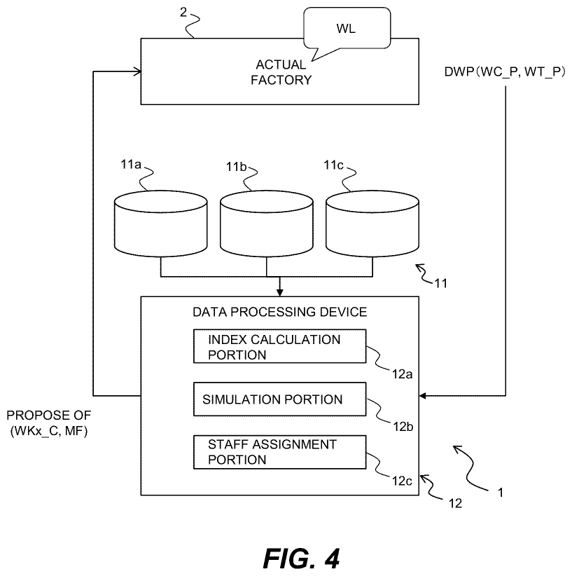

FIG. 4 is a diagram for illustrating a configuration example of the system according to the embodiment. The simulation system 1 shown in FIG. 4 includes a database 11 and a data processing device 12 as a configuration for performing a simulation (that is, digital twin simulation) using a digital space that reproduces a real space in the actual factory 2 in which the work line WL is provided.

The database 11 is formed inside a hard disk or a flash memory, for example. In the example shown in FIG. 4, the database 11 includes three types of databases 11a, 11b, and 11c. The mounting fixture data DMF is stored in the database 11a. The database 11b stores worker data DWK. The database 11c stores worker data DWK_DTS for DTS.

The mounting fixture data DMF represents data related to the mounting fixture MF. The mounting fixture MF is set according to the work contents WC of the multiple works executed in the work line WL. As described above, the mounting fixture MF includes a mounting fixture MF that is required to be worn by the worker WKx by laws, regulations, or the like and a mounting fixture MF that is not required to be worn by the worker WKx. Therefore, the mounting fixture data DMF includes data related to the mounting fixture MF which is obliged to wear and data related to the mounting fixture MF which is arbitrary to wear.

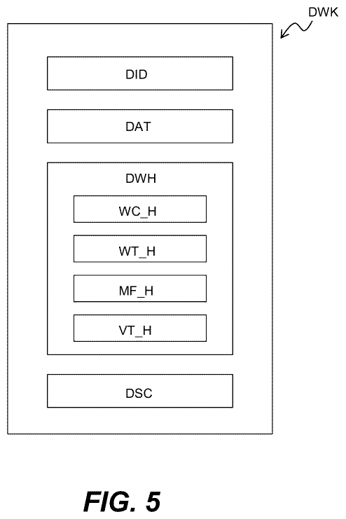

The worker data DWK represents data related to multiple workers arranged in the work line WL. The worker data DWK is also a set of data related to the worker WKx. FIG. 5 is a diagram for illustrating a configuration example of the worker data DWK. In the example shown in FIG. 5, the worker data DWK includes identification data DID, attribution data DAT, work history data DWH, and schedule data DSC.

The identification data DID represent data for identifying the worker WKx. The attribution data DAT represents data related to the attribution AT of the worker WKx. As described above, the attribution AT is determined by the attributing elements such as the basic attributes such as age and gender, the physical attributes such as height and weight, and the labor attributes such as the number of years of experience of the work in the work line WL.

The work history data DWH represents data relating to the work history of the worker WKx. In the example illustrated in FIG. 5, the work history data DWH includes work content data WC_H, work time data WT_H, mounting fixture data MF_H, and vital data VT_H.

The work content data WC_H represents history data related to the work of the work contents WC in which the worker WKx is engaged. The work time data WT_H represents history data related to the time when the worker WKx engaged in the work of the work contents WC. The work time data WT_H is generated for each work contents WC. The mounting fixture data MF_H represents history data related to the mounting fixture MF worn by the worker WKx when the worker WKx engaged in the work of the work contents WC. As with the work time data WT_H, the mounting fixture data MF_H is generated for each work contents WC. The vital data VT_H represents data relating to the physical condition of the worker WKx, such as pulse, blood pressure, and body temperature. The vital data VT_H is acquired from, for example, a measurement tool worn by the worker WKx. Like the work time data WT_H, the vital data VT_H is generated for each work contents WC.

The schedule data DSC represents data related to the schedule SC of the worker WKx. The schedule SC of the worker WKx is, for example, a work schedule of the worker WKx for a certain period (for example, one day, one week, or one month). The work schedule includes information such as a time zone in which the work contents WC are scheduled to be arranged in the work line WL, a time zone in which the work contents WC are scheduled to be engaged in a task other than the work contents WC in the work line WL, and a time zone in which the work contents WC are scheduled to take a break.

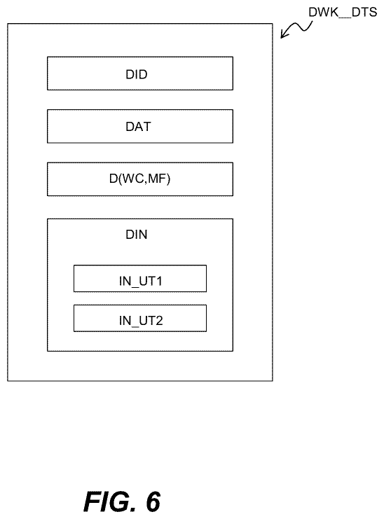

The worker data DWK_DTS is a set of data related to the worker WKx used for the DTS. FIG. 6 is a diagram for illustrating a configuration example of worker data DWK_DTS. In the example shown in FIG. 6, the worker data DWK includes identification data DID, attribution data DAT, combination data D (WC, MF), and index data DIN. Some data (specifically, identification data DID and attribution data DAT) of the data constituting the worker data DWK_DTS are common to the data constituting the worker data DWK_DTS.

The combination data D (WC, MF) and the index data DIN are data unique to the worker data DWK_DTS. The combination data D (WC, MF) represents data of a combination (WC, MF) of the work contents WC and the mounting fixture MF for the worker WKx. The combination data D (WC, MF) is generated based on, for example, the work history data DWH (specifically, the work content data WC_H and the mounting fixture data MF_H) for the worker WKx. The index data DIN represents data related to the index IN_WE_WKx. The index data DIN is generated for each combination (WC, MF) of the worker WKx based on the work history data DWH (specifically, vital data VT_H) of the worker WKx, for example.

In the example shown in FIG. 6, the index data DIN includes first index data DIN_UT1 and second index data DIN_UT2. The first index data DIN_UT1 represents data of the first index IN_UT1, and the second index data DIN_UT2 represents data of the second index IN_UT2. The first index IN_UT1 is calculated using the variation per the first time UT1 in data relating to the physical condition included in the vital data VT_H. The second index IN_UT2 is calculated using the variation per second time UT2 of the physical condition. The first time UT1 and the second time UT2 are two kinds of unit times UT shown in FIG. 2. As the variation of the data relating to the physical condition, the variation ΔFA of the fatigue level FA mentioned in the description of FIG. 2 is exemplified.

The data processing device 12 is a computer including at least one processor and at least one memory device. The at least one processor includes a central processing portion (CPU). At least one memory device stores a program for executing index calculation processing, DTS, staff assignment processing, and other data processes. These programs may be stored in a recording medium readable by the data processing device 12.

### 3-2. Function Configuration Example of Data Processing Device

In FIG. 4, an index calculation portion 12a, a simulation portion 12b, and a staff assignment processing portion 12c are depicted as functions of the data processing device 12. These functions are realized by the processor of the data processing device 12 executing various programs stored in the memory device of the data processing device 12.

The index calculation portion 12a performs a calculation process of the index IN_WE_WKx. In this calculation process, the index IN_WE_WKx while the worker WKx is engaged in the work of the work contents WC is calculated based on the worker data DWK (to be more specific, the work history data DWH) stored in the database 11b. The index IN_WE_WKx may be calculated focusing on a single unit time UT or may be calculated focusing on a plurality of unit times UT. The index IN_WE_WKx obtained by the calculation processing is stored in the database 11c in association with the combination data D (WC, MF) for the worker WKx. The data of the index IN_WE_WKx is the index data DIN for the worker WKx.

The simulation portion 12b performs DTS. In this DTS, first, a combination (WKx, MF) of one worker WKx and a mounting fixture MF worn by this worker WKx is assigned to each of the work contents WC of multiple works being executed in the work line WL. A combination (WKx, MF) of one worker WKx and a mounting fixture MF worn by the worker WKx may be assigned to each of the work contents WC of the multiple works to be performed in the work line WL.

The work contents WC of multiple works being executed in the work line WL and the work contents WC of multiple works to be performed in the work line WL are specified from the work plan data DWP of the work line WL. Here, the work plan data DWP is separately set by, for example, a computer included in the actual factory 2. The work plan data DWP includes, for example, data of work contents WC_P being executed (or scheduled to be executed) in the work line WL and data of time WT_P for executing (or scheduled to be executed) the work of the work contents WC_P. Therefore, the work contents WC of the multiple works is specified by referring to the data of the work contents WC_P.

When the combination (WKx, MF) is distributed, the index IN_WE_WKx for the worker WKx constituting the combination (WKx, MF) is specified. The index IN_WE_WKx is specified by referring to the database 11c using the assigned combination (WKx, MF). The combination (WKx, MF) is assigned to each of the work contents WC of the multiple works. Therefore, the index IN_WE_WKx is also specified for each of the work contents WC of the multiple works. That is, the number of the identified index IN_WE_WKx is equal to the number of the work contents WC of the multiple works.

When the index IN_WE_WKx is specified, the work efficiency WE_WWL is calculated based on the index IN_WE_WKx. The work efficiency WE_WWL is calculated using, for example, a calculation formula in which the specified index IN_WE_WKx is a variable.

As described with reference to FIG. 3, the assignment of the combination (WKx, MF) to the work contents WC of the multiple works is performed for all the patterns CP of the combinations (WKx, MF) that can be assigned (CP1 to CPn). Therefore, the work efficiency WE_WWL is calculated for each pattern CP of the combination (WKx, MF).

When the work efficiency WE_WWL is calculated for each pattern CP of the combination (WKx, MF), the work efficiency WE_WWL is selected using the reference condition. In this way, in the DTS, the pattern CP of the combination (WKx, MF) (that is, the group CG of the combination (WK, MF) corresponding to the work efficiency WE_WWL satisfying the reference condition is searched. As a result of the selection using the reference condition, two or more groups CG of the combination (WKx, MF) corresponding to the work efficiency WE_WWL satisfying the reference condition may remain. In this case, it is desirable to select these groups CG and arrange these groups CG in the order in which the score of work efficiency WE_WWL is in descending order, because this is in accordance with the object of the present disclosure.

The staff assignment processing portion 12c performs staff assignment processing for arranging workers on the work line WL of the real space. In the staff assignment processing, a combination (WKx_C, MF) of a candidate WKx_C of the worker WKx assigned to each of the multiple works to be performed in the work line WL and the mounting fixture MF worn by the candidate WKx_C is selected with reference to the search result by the DTS. The selected combination (WKx_C, MF) is output from the data processing device 12. Thus, the selected combination (WKx_C, MF) is proposed. The decision to adopt this proposal is made by, for example, the person in charge of the work line WL in real space.

The multiple works to be performed in the work line WL is specified from the work plan data DWP of the work line WL. As described above, the work plan data DWP includes data of the work contents WC_P scheduled to be executed in the work line WL and data of the time WT_P scheduled to execute the work of the work contents WC_P. Therefore, by referring to the data of the work contents WC_P, the multiple works to be executed and the work contents WC of these works are specified.

When the multiple works to be performed in the work line WL and the work contents WC of these works are specified, the mounting fixture MF is specified by referring to the database 11a using the work contents WC. As described above, the mounting fixture data DMF is stored in the database 11a, and the mounting fixture data DMF is related to the mounting fixture MF set according to the work contents WC. Therefore, by referring to the mounting fixture data DMF, the mounting fixture MF corresponding to the work contents WC of the multiple works to be performed in the work line WL is specified.

When multiple works to be performed in the work line WL, the work contents WC of these works, and the mounting fixture MF corresponding to these work contents WC are specified, the candidate WKx_C is specified. For example, the data of the time WT_P included in the work plan data DWP and the schedule data DSC are referred to, and the candidate WKx_C whose time zone of the arrangement schedule to the work line WL overlaps the time zone of the time WT_P is specified. The number of persons of the candidate WKx_C specified at this stage is normally two or more.

When the candidate WKx_C is specified, the candidate WKx_C and the search result by the DTS are referred to. According to the search by the DTS, the group CG of the combination (WKx, MF) corresponding to the work efficiency WE_WWL satisfying the reference condition is selected. Therefore, if the worker WKx constituting the group CG of the combination (WKx, MF) is included in the candidate WKx_C specified by referring to the schedule data DSC, the worker WKx is specified as the candidate WKx_C. When the worker WKx is identified as the candidate WKx_C, the combination (WKx, MF) including the worker WKx is selected as the combination (WKx_C, MF).

When there are two or more groups CG of the combination (WKx, MF) corresponding to the work efficiency WE_WWL satisfying the reference condition, the schedule data DSC is referred to in order from the group CG of the combination (WKx, MF) having the highest work efficiency WE_WWL. Therefore, for example, when the work schedules of some or all workers WKx constituting the group CG of the combination (WKx, MF) having the highest work efficiency WE_WWL do not match the work plan of the work line WL, the combination (WKx, MF) having the second highest work efficiency WE_WWL can be examined. By referring to the combinations in such an order, it is possible to suppress a situation in which the combination (WKx_C, MF) cannot be selected. At the same time, it is possible to select the combination (WKx_C, MF) based on the group CG of the combination (WKx, MF) having higher work efficiency WE_WWL.

In the case where there is only one group CG of the combination (WKx, MF) corresponding to the work efficiency WE_WWL satisfying the reference condition, when the work schedule of some workers WKx constituting the group CG does not match the work plan of the work line WL, data (that is, attribution data DAT) regarding the attribution AT of the multiple workers constituting the group CG may be referred to. By referring to the attribution data DAT, it is possible to specify another worker WKx having the same attribution AT as the attribution AT of the worker WKx which does not match the work plan of the work line WL and having a work schedule which matches the work plan of the work line WL as the candidate WKx_C. The attribution data DAT is stored in the database 11b.

Even when there are two or more groups CG of the combination (WKx, MF) corresponding to the work efficiency WE_WWL satisfying the reference condition, the attribution data DAT may be referred to. For example, when the work schedules of some or all workers WKx constituting the group CG of the combination (WKx, MF) having the highest work efficiency WE_WWL do not match the work plan of the work line WL, another worker WKx having the same attribution AT as the worker WKx that does not match the work plan and having a work schedule matching the work plan of the work line WL can be specified as the candidate WKx_C.

### 4. Effect

According to the embodiment described above, it is possible to specify the group CG of the combination (WK, MF) when the reference condition is satisfied in the DTS. Then, when the work line WL of the real space is operated with reference to the group CG of the specified combination (WK, MF), it is expected that the work efficiency WE_WWL of the entire work line WL is increased.

What is claimed is:

1. A simulation system, comprising:
a database in which data related to multiple workers arranged in a work line of a real space, data related to mounting fixtures worn by the respective multiple workers, and data related to indexes on work efficiency of the multiple workers, in association with work contents of multiple works performed in the work line of the real space; and
a processor configured to perform a simulation on a work line in a digital space corresponding to the work line in the real space based on data related to a work plan in the work line in the real space and data stored in the database,
wherein, in the simulation, the processor is configured to:
assign combinations of workers and mounting fixtures worn by the workers to each of the work contents of the multiple works performed in the work line of the digital space based on the data related to the work contents of the multiple works to be performed, and the data related to the multiple workers and the data related to the mounting fixture stored in the database; and
based on the assigned combinations and the data related to the indexes stored in the database, which are data of indexes related to work efficiencies of the worker constituting the assigned combinations, search for a group of combinations of the multiple workers and the mounting fixtures worn by the respective multiple workers, in a case where a reference condition in which work efficiency in a whole work line of the digital space is equal to or greater than a target value is satisfied.

2. The simulation system according to claim 1,
wherein the processor further configured to perform staff assignment processing to arrange workers in the work line of the real space,
wherein, in the staff assignment processing, the processor is configured to:
based on data of the work contents of the multiple works to be performed and the data related to the mounting fixtures used in accordance with the work contents, specify a group of combinations of the work contents of the multiple works to be performed and the mounting fixtures used in accordance with the work contents; and
select a candidate group indicating a group of combinations of candidates of the workers to be assigned to the specified group of combinations and the mounting fixture worn by the candidates of the workers by referring to data of schedule of the workers scheduled to be arranged in the work line of the real space using a search result by the simulation.

3. The simulation system according to claim 2,
wherein, in the staff assignment processing, the processor is further configured to:
when the search result obtained by the simulation includes two or more groups of combinations satisfying the reference condition, perform the reference using the data of the schedules of the workers scheduled to be arranged in order from the group of combination having high work efficiency in the whole work line.

4. The simulation system according to claim 2,
wherein, in the database, the work contents of the multiple works performed in the work line of the real space are further associated with data related to attributes of the multiple workers,
wherein, in the staff assignment processing, the processor is configured to:
based on the search result obtained by the simulation, specify attributes of the multiple workers constituting the group of combinations that satisfies the reference condition,
wherein, the attributes of the specified multiple workers are further referred to in the selection of the candidate group of combinations of the candidates of the workers to be arranged to the multiple works to be performed respectively and the mounting fixture worn by the candidates of the workers,
wherein, the candidate group of combinations of the candidates of the workers to be arranged to the multiple works to be performed respectively and the mounting fixture worn by the candidates of the workers include another worker having the same attribute as the specified attributes of the multiple workers.

5. A non-transitory computer-readable medium storing a simulation program, the simulation program causing a computer to perform a simulation in a work line of a digital space corresponding to a work line of a real space,
wherein, in the simulation, the simulation program causes the computer to perform:
assign combinations of workers and mounting fixtures worn by the workers to each of multiple works performed in the work line of the digital space, based on data of work contents of the multiple works to be performed in the work line of the real space, data related to multiple workers arranged in the work line of the real space, and data related to mounting fixtures worn by the multiple workers; and
based on the assigned combinations and data of indexes related to work efficiencies of the workers constituting the assigned combinations, search for a group of combinations of the multiple workers and the mounting fixtures worn by the respective multiple workers in a case where a reference condition in which work efficiency in a whole work line of the digital space is equal to or greater than a target value is satisfied.
